(19) United States
(12) Patent Application Publication
(10) Pub. No.: US 2021/0178530 A1
(43) Pub. Date: Jun. 17, 2021

(54) SYSTEMS AND METHODS FOR PROCESSING SLIDING MECHANISMS

(71) Applicant: Loon LLC, Mountain View, CA (US)

(72) Inventors: Nathan Winder, San Jose, CA (US); Derek Herbert, Mountain View, CA (US)

(21) Appl. No.: 16/713,949

(22) Filed: Dec. 13, 2019

(51) Int. Cl. B23P 11/02; G01K 7/22

(52) U.S. Cl. CPC B23P 11/025; G01K 7/22

(57) ABSTRACT

Aspects of the disclosure relate to processing sliding mechanisms. For instance, an assembly including a first component having a first sliding mechanism may be heated to a first minimum temperature for a first minimum period of time. Thereafter, a second component is pressed onto the assembly a first time such that the second component contacts the first sliding mechanism. Thereafter, the second component and the assembly may be subjected to a below-freezing temperature for a second minimum period of time. Thereafter, the second component may be separated from the assembly. The first sliding mechanism may be rotated relative to the first component. Thereafter, the second component may be pressed onto the assembly a second time such that the second component contacts the first sliding mechanism. Thereafter, the first component and the assembly may be heated to a second minimum temperature for a third minimum period of time.

### BACKGROUND

Various systems may require a predetermined amount of stress, or preloading, in order to function properly or ensure a particular fit or configuration of adjoining parts. In some instances, preloading mechanisms may include sliding mechanisms, such as O-rings, piston rings (in car motors), tolerance rings, springs, dowel pins, machine keys, or any shaped feature used to create one or more sliding surfaces. As an example, these sliding mechanisms may be formed thermoplastic materials such as graphite filled Polytetrafluoroethylene (PTFE), PTFE without the graphite, HDPE (high density polyethylene), DELRIN®, polyoxymethylene, as well as other polymers.

### BRIEF SUMMARY

Aspects of the disclosure provide a method of processing sliding mechanisms. The method includes heating an assembly to a first minimum temperature for a first minimum period of time, the assembly including a first component having a first sliding mechanism arranged thereon; after heating assembly to the first minimum temperature for the first minimum period of time, pressing a second component onto the assembly a first time such that the second component contacts the first sliding mechanism; after pressing the second component onto the assembly the first time, subjecting the second component and the assembly to a below-freezing temperature for a second minimum period of time; after the subjecting, separating the second component from the assembly; rotating the first sliding mechanism relative to the first component; after the rotating, pressing the second component onto the assembly a second time such that the second component contacts the first sliding mechanism; and after pressing the second component onto the assembly the second time, heating the first component and the assembly to a second minimum temperature for a third minimum period of time.

In one example, wherein the assembly further includes a second sliding mechanism arranged on the first component, and the method includes rotating the second sliding mechanism relative to the first component prior to pressing the second component onto the assembly a second time. In another example, the method also includes, prior to heating the assembly to the first minimum temperature, placing the assembly on a fixture in order to provide support for the assembly during processing. In another example, the method also includes attaching a thermistor to the first component. In this example, the method also includes using the thermistor to confirm that the first component has been heated to the first minimum temperature for the first minimum period of time. In addition or alternatively, the method also includes using the thermistor to confirm that the first component has been heated to the second minimum temperature for the third minimum period of time. In another example, the method also includes, after pressing the second component onto the assembly the first time and prior to the subjecting allowing the first component to gradually cool to a particular temperature. In this example, the particular temperature is at or less than 25 C. In another example, the method also includes, after the subjecting, allowing the first component to gradually cool to a particular temperature. In this example, the particular temperature is at or less than 25 C. In another example, the method also includes, after heating the first component and the assembly to the second minimum temperature for the third minimum period of time, allowing the first component to gradually cool to a particular temperature. In this example, the particular temperature is at or less than 25 C. In another example, the first minimum temperature is at least 85 C. In another example, the first minimum period of time is at least 15 minutes. In another example, the second minimum temperature is at least 85 C. In this example, the third minimum period of time is at least 15 minutes. In another example, the third minimum period of time is at least 15 minutes. In another example, the rotating includes rotating the sliding mechanism between 90 and 180 degrees relative to the first component. In another example, the sliding mechanism is a graphite-filled PTFE O-ring. In another example, the first component, second component, and the first sliding mechanism are components of a preloading mechanism, and the method further comprises, after heating the first component and the assembly to the second minimum temperature for the third minimum period of time, assembling the preloading mechanism.

### BRIEF DESCRIPTION OF THE DRAWINGS

FIG. 1 is an example diagram of aspects of a preloading mechanism in accordance with aspects of the disclosure.

FIG. 2 is an example of an assembly in accordance with aspects of the disclosure.

FIG. 4 is an example of an assembly and a holder in accordance with aspects of the disclosure.

FIG. 4 is an example process for pressing a bearing hub cylinder to an assembly in accordance with aspects of the disclosure.

FIG. 5-7 are examples of assembling a preload mechanism in accordance with aspects of the disclosure.

FIG. 8 is an example flow diagram in accordance with aspects of the disclosure.

### DETAILED DESCRIPTION

### Overview

The present disclosure generally relates to processing sliding mechanisms to particular dimensions for a given use. For instance, certain systems may require a predetermined amount of stress, or preloading, in order to function properly or ensure a particular fit or configuration of adjoining parts. In some instances, bearings or preloading mechanisms may include sliding mechanisms, such as O-rings, piston rings (in car motors), tolerance rings, springs, dowel pins, machine keys, or any shaped feature used to create one or more sliding surfaces. As an example, these sliding mechanisms may be formed thermoplastic materials such as graphite filled PTFE, PTFE without the graphite, HDPE, DELRIN®, polyoxymethylene, as well as other polymers.

Such materials may have a very low coefficient of friction. However, friction is also highly dependent on the normal force in the direction of the friction. This normal force increases as the sliding mechanisms are compressed. If the compression force is too great, the friction may prevent the preload mechanism from sliding. If the compression force is too low or if there is a loose fit with the sliding mechanisms, the adjoining parts to which the stress is applied may be damaged by impact or vibration due to lack of adequate restraint. To avoid such situations, the sliding mechanisms need to have a very tight machined tolerance, for instance on the order of less than 10 microns in total. Current approaches, such as molding, can be risky due to high capital costs and uncertainty that the needed tolerance band can be achieved. Similarly, machining is also cost prohibitive and typically cannot hit less than 0.1 mm tolerance band on machined plastic parts.

To address this, the sliding mechanisms can be processed to form them to the required tolerance band as well as the ideal dimension needed for the combination of other parts that are fit together. The process may involve heating, freezing, and tempering, in order to create a final formed dimension of the sliding mechanisms to be a final dimension needed to create both a tight fit as well as a free enough sliding fit to allow for preload mechanisms to last for significant periods of time. In other words, the useful lifetime of the sliding mechanism, and also the device in which such sliding mechanisms are used, is significantly increased.

The features described herein may provide a process that may involve heating, freezing, and tempering, in order to create a final formed dimension of sliding mechanisms to be a final dimension needed to create both a tight fit as well as a free enough sliding fit to allow for preload mechanisms to last for significant periods of time. In other words, the useful lifetime of the bearing is significantly increased as the sliding mechanisms are neither too loose nor too tight and time-zero design specification may also be met. In addition, overall capital costs of a preload mechanism may be reduced dramatically, for instance by as much as 90%. In this regard, the aforementioned process may avoid the use of certain expensive and difficult to manufacture parts, while increasing the tolerance of the sliding mechanism, bearing hub cylinder and holder while tightly controlling the precision of these parts, for instance, less than a 25 micron difference. In some instances, the process described herein may allow for the user of dramatically over-sized O-rings to be formed into an optimal fit with other parts and thereby greatly simplifying the supply chain by reducing the possibility of quality non-conformities.

### Example Systems

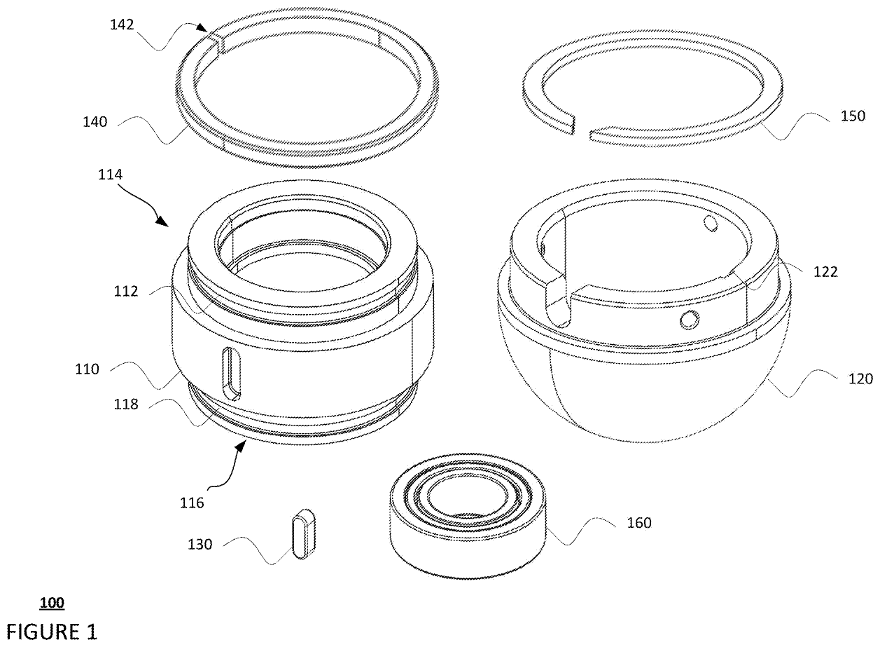

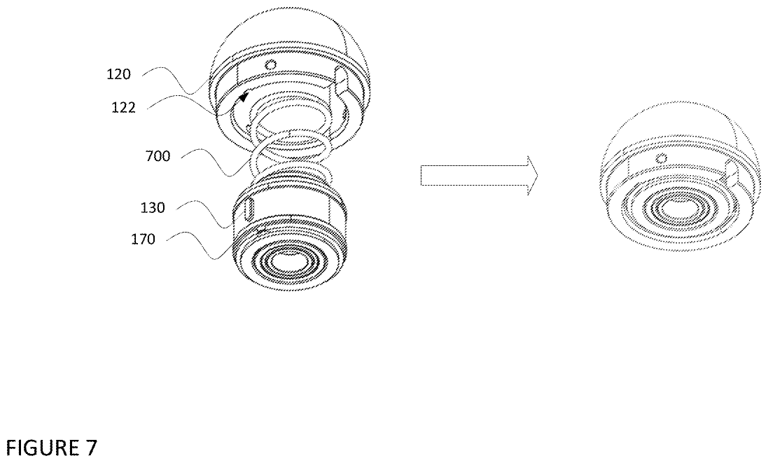

FIG. 1 depicts an example bearing or preload mechanism 100. The preload mechanism 100 may include a plurality of components including a bearing mount or holder 110, bearing hub cylinder 120, a machine key 130, a pair of sliding mechanisms 140 (depicted as an O-ring and only 1 shown), a pair of retaining rings 150 (only 1 shown), bearing 160 (which may drive the requirements for concentricity and precision in the processing described herein), and a spring 700 (shown in FIG. 7).

The holder 110 may be made of stainless steel, such as 416 stainless steel. The surfaces of the bearing hub cylinder need not have a particular surface finish as there may be no actual contact between the bearing hub cylinder and the holder when the preload mechanism is fully assembled. Rather, the only contact is between one of the sliding mechanisms and the bearing hub cylinder.

The bearing hub cylinder 120 may be made of hardened 416 stainless steel. However, other metals may also be used for the holder 110 and bearing hub cylinder 120, for instance, so long as the coefficient for thermal expansion for the holder and the bearing hub cylinder are lower, for example on the order of 10 times or more or less, than that of the material of the sliding mechanism 140. A surface finish may be applied to ensure a certain roughness of the surfaces of the holder, such as a 0.4 RA surface finish or more or less, in order to control variations in the dimensions of the surfaces of the bearing hub cylinder, thereby resulting in a controlled dimension for a known normal force after processing.

Although depicted as an O-ring in the figures, the sliding mechanisms discussed herein may include O-rings, piston rings (in car motors), tolerance rings, springs, dowel pins, machine keys, or any shaped feature used to create one or more sliding surfaces. As an example, the sliding mechanisms 140 may be formed thermoplastic materials such as graphite filled PTFE, PTFE without the graphite, Dehin, polyoxymethylene, as well as other polymers. The sliding mechanisms 140 may also have a kerf cut or split 142 therein.

The retaining rings 150 may be made of 416 stainless steel, carbon steel, or other suitable materials. In addition, the outer diameter of the sliding mechanisms 140 may be slightly larger than the outer diameter of the retaining rings 150 in order to ensure that the retaining rings do not contact that bearing hub cylinder. In this regard, the retaining rings and sliding mechanisms may be paired, and each pair may have the same or different dimensions, materials, etc. as the other pair.

### Example Methods

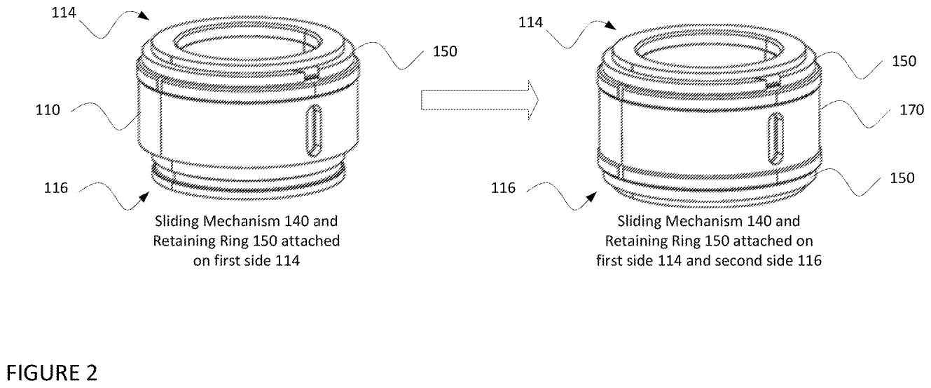

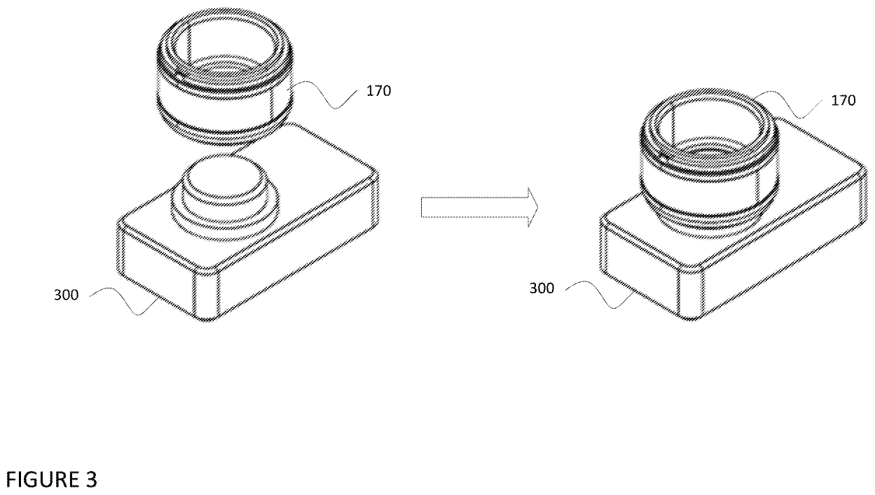

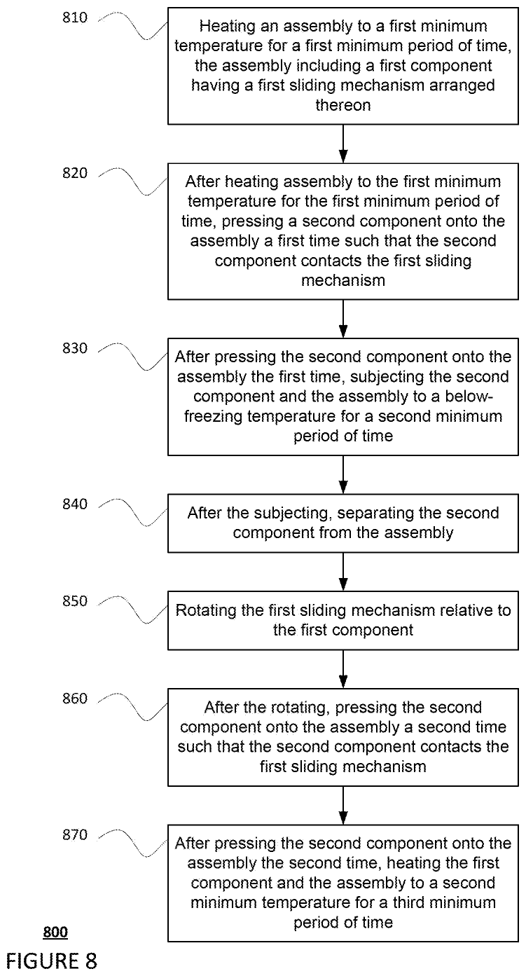

FIG. 8, provides an example flow diagram 800 for processing sliding mechanisms in accordance with some of the aspects described herein. Prior to the aforementioned processing, the sliding mechanisms 140 and retaining rings 150 may be assembled with the holder 110 (hereafter “the assembly 170”). For instance, one of the sliding mechanisms 140 may be placed into a groove 112 or around a projection of a first side 114 of the holder 110 for instance, using retaining ring pliers or other application tools. This process may be repeated for another of the sliding mechanisms 140, the second side 116 and second groove 118 of the holder 110, and a second one of the retaining rings 150 resulting in the assembly 170 as depicted in FIG. 2.

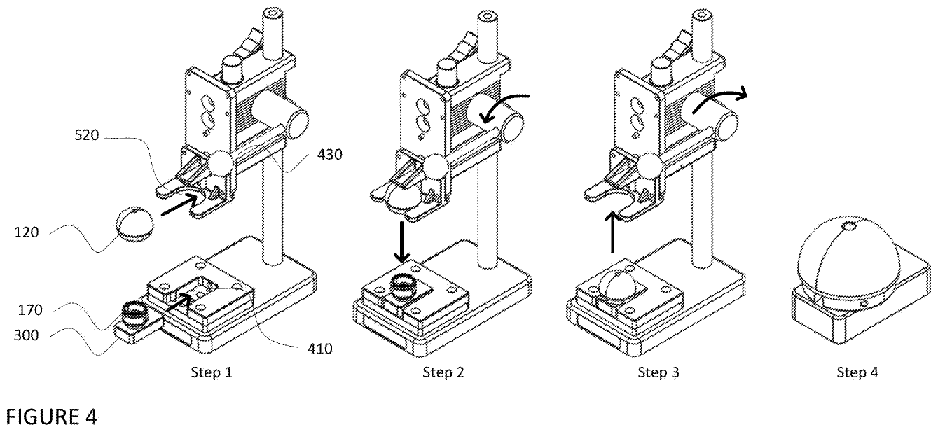

Turning to block 810 of FIG. 9, an assembly is heated to a first minimum temperature for a first minimum period of time, the assembly 170 including a first component having a first sliding mechanism arranged thereon. For instance, the assembly 170 may be placed on a workpiece or fixture 300 as shown in FIG. 4, in order to provide support for the assembly 170 during processing. In addition, a thermistor may be placed, attached or otherwise arranged on the holder in order to allow for the monitoring of process and component temperatures. At this point, the fixture and the assembly 170 may be heated to a minimum temperature, such as 85 C or more or less, using an oven or other device. This temperature may be maintained for a first minimum period of time, such as 15 minutes or more or less. For instance, the fixture 300 and the assembly 170 may be heated in an oven at approximately 105 C until the temperature of the holder 110 is at least 85 C for 15 minutes. This heating may expand the size of the sliding mechanisms, for example increasing the outer diameters 8 to 10 microns, as compared to room temperature. The temperature of the holder may be confirmed using the thermistor. Thereafter, the fixture 400 and the assembly 170 may be removed from the oven.

Returning to FIG. 8, at block 820, after heating assembly to the first minimum temperature for the first minimum period of time, pressing a second component onto the assembly 170 a first time such that the second component contacts the first sliding mechanism. For instance, immediately thereafter, the bearing hub cylinder 120 may be assembled onto a first side of the holder of the assembly 170. The fixture 300 with the assembly 170 may be slid into a base portion 410 of a press 400 as shown in step 1 FIG. 4, and the bearing hub cylinder may be slid into a holder portion 420 of the press 400. The press 400 may then be activated as shown in step 2 of FIG. 4, for instance by turning a crank 430, in order to force or press the bearing hub cylinder 120 onto the holder 110 with a certain force by moving the holder portion 420 towards the base portion 410. The crank may then be activated in reverse as shown in step 3, to move the holder portion 420 away from the base portion 410. Thereafter, the assembly 170 with the bearing hub cylinder 120 attached may be removed from the press 400 as shown in step 4. When the bearing hub cylinder 120 is pressed onto the assembly 170, the bearing hub cylinder may be at room temperature (e.g. 20-25 C) while the assembly 170 may be approximately 85 degrees or more. The expanded size of the sliding mechanisms may create a very tight seal between the sliding mechanism and the bearing hub cylinder.

Thereafter, the assembly 170 with the bearing hub cylinder 120 attached may be cooled to room temperature (e.g. 20-25 C), before or after the fixture 300 is removed from the base portion of the press 400. Again, the temperature of the holder 110 may be confirmed using the thermistor.

Returning to FIG. 8, at block 830, after pressing the second component onto the assembly the first time, the second component and the assembly are subjected to a below-freezing temperature for a second minimum period of time. For instance, the fixture 400 and the assembly 170 with the bearing hub cylinder 120 attached may be subjected to temperatures below freezing for a second minimum period of time. This second minimum period of time may be 15 minutes or more or less. For instance, the fixture and the assembly 170 with the bearing hub cylinder attached may be placed into a freezer and cooled for at least 15 minutes. The freezer may be at approximately −10 C or lower temperatures such that when the fixture 300 and the assembly 170 with the bearing hub cylinder 120 reach that temperature while in the freezer. Thereafter, the fixture 300 and the assembly 170 with the bearing hub cylinder 120 attached may be removed from the freezer. The effect of the freezing may cause the sliding mechanism 140 to shrink faster than the attached holder 110 and bearing hub cylinder 120. The sliding mechanism may shrink and therefore have room to shift as it is no longer compressed between the holder 110 and bearing hub cylinder 120. This freezing also helps to set the sliding mechanisms after the heating.

Thereafter, the fixture and the assembly 170 with the bearing hub cylinder 120 attached may be allowed to come to, or rather, to return to, room temperature (e.g. 20-25 C). This cooling may be allowed to occur gradually, for example, the assembly 170 may simply be exposed to such temperatures. Again, the temperature of the holder 110 may be confirmed using the thermistor.

At block 840, after the subjecting, the second component is separated from the assembly. For instance, once at room temperature, the bearing hub cylinder 120 and the assembly 170 may then be separated from one another. Because the one sliding mechanism 140 in contact with the bearing hub cylinder 120 and the bearing hub cylinder are now near perfectly fit to one another, the bearing hub cylinder 120 and the assembly 170 may come apart relatively easily.

At block 850, the first sliding mechanism is rotated relative to the first component; For instance, the sliding mechanisms may be rotated relative to the holder. This may create some interference between the sliding mechanisms and the holder. For example, the sliding mechanisms may be rotated 80 to 180 degrees thereby creating 1-2 microns of interference. As such, the sliding mechanisms go from a perfect or near perfect fit with the holder to one with some interference. In addition, any debris caused by the pressing, separating, or rotating may be cleaned, for instance with a brush, puff of air, or other method.

At block 860, after the rotating, pressing the second component onto the assembly a second time such that the second component contacts the first sliding mechanism. For instance, after rotating the sliding mechanisms 140, the bearing hub cylinder 120 may be assembled onto the first side 114 of the holder 110 of the assembly 170 as shown in FIG. 4.

At block 870, after pressing the second component onto the assembly the second time, the first component and the assembly are heated to a second minimum temperature for a third minimum period of time. The fixture 400 and the assembly 170 with the attached bearing hub cylinder 120 may again be heated to a minimum temperature, such as 85 C or more or less. This temperature may be maintained for a third minimum period of time, such as 15 minutes or more or less. For example, the fixture and the assembly 170 may be heated in the oven at approximately 105 C until the temperature of the holder is at least 85 C for 15 minutes. This second heating may have a similar expansion effect on the sliding mechanisms 110 as the first heating (e.g. an increase of 8 to 10 microns or more or less), but the initial dimensions of the sliding mechanisms would be smaller. In other words, the initial heating and cooling in the process forms a cross-section of the sliding mechanisms 140 into a smaller width. Therefore, the outer diameter of the sliding mechanisms 140 and holder 110 is smaller after the initial heating and cooling. When heated a second time, the 8-10 micron expansion may occur from the new smaller diameter created by the initial heating and cooling. The temperature of the holder 110 may be confirmed using the thermistor. Thereafter, the fixture 300 and the assembly 170 may be removed from the oven.

The fixture 400 and the assembly 170 with the bearing hub cylinder 120 attached may be cooled to room temperature (e.g. 20-25 C). This cooling may be allowed to occur gradually, for example, the assembly 170 may simply be exposed to such temperatures. Again, the temperature of the holder may be confirmed using the thermistor. The assembly 170 with the bearing hub cylinder 120 may then be removed from the assembly 170. The cooling may make this removal easier.

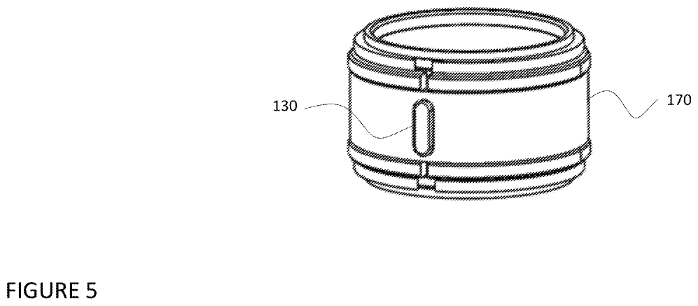

The preload mechanism 100 may then be assembled. FIGS. 5-7 provide examples of assembling a preload mechanism. For example, turning to FIG. 5, the machine key may be inserted into an opening 111 (FIG. 1) in a sidewall 113 of the holder 110. To ensure a secure fit, the machine key 130 may be glued in place using epoxy or other adhesive substances suitable for the use of the pre-load mechanism. In some implementations, the machine key need not be used.

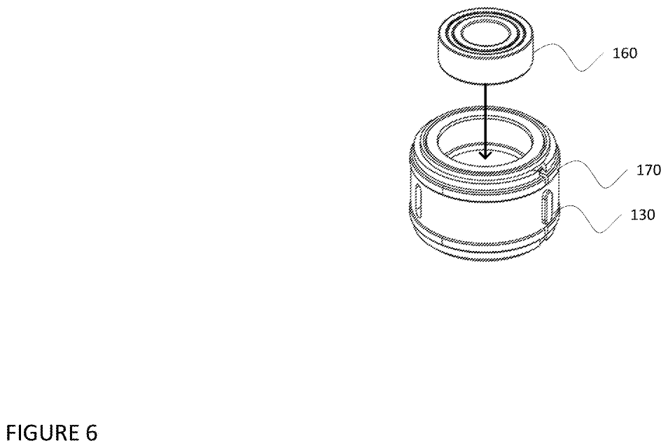

The bearing 160 may then be inserted into the assembly 170 as shown in FIG. 6. The bearing 160 may be fixed or attached within a central opening 115 of the holder 110 using epoxy or other adhesive substances suitable for the use of the pre-load mechanism. The assembly 170 with the attached may then be heated in an over at 60 C for at least 4 hours or more or less.

The assembly 170 with the attached machine key 130 and bearing 160 may be attached to the device in which the preload mechanism 100 may be used. For example, the opening 115 of the holder 110 may be positioned on a motor rotor shaft of a compressor (not shown) or other device. Thereafter, a spring 700 may be inserted into the bearing hub cylinder as shown in FIG. 8. In this regard, the spring may contact the holder. The bearing hub cylinder 130 may then be placed over the spring which may then be compressed by applying a force on the bearing hub cylinder 120 in order to move these parts towards one another. The machine key 130 may slide into an internal slot or groove 122 of the bearing hub cylinder 120. The bearing hub cylinder 120 may then be fixed in place with respect to the motor rotor shaft and/or a motor housing of the compressor, for example using one, two, three or more screws.

The features described herein may provide a process that may involve heating, freezing, and tempering, in order to create a final formed dimension of the O-rings to be a final dimension needed to create both a tight fit as well as a free enough sliding fit to allow for preload mechanisms to last for significant periods of time. In other words, the useful lifetime of the bearings is significantly increased as the sliding mechanisms are neither too loose nor too tight and time-zero design specification may also be met. In addition, overall capital costs of a preload mechanism may be reduced dramatically, for instance by as much as 90%. In this regard, the aforementioned process may avoid the use of certain expensive and difficult to manufacture parts, while increasing the tolerance of the O-ring, bearing hub cylinder and holder while tightly controlling the precision of these parts, for instance, less than a 25 micron difference. In some instances, the process described herein may allow for the user of dramatically over-sized O-rings to be formed into an optimal fit with other parts and thereby greatly simplifying the supply chain by reducing the possibility of quality non-conformities.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method of processing sliding mechanisms, the method comprising:
heating an assembly to a first minimum temperature for a first minimum period of time, the assembly including a first component having a first sliding mechanism arranged thereon;
after heating assembly to the first minimum temperature for the first minimum period of time, pressing a second component onto the assembly a first time such that the second component contacts the first sliding mechanism;
after pressing the second component onto the assembly the first time, subjecting the second component and the assembly to a below-freezing temperature for a second minimum period of time;
after the subjecting, separating the second component from the assembly;
rotating the first sliding mechanism relative to the first component;
after the rotating, pressing the second component onto the assembly a second time such that the second component contacts the first sliding mechanism; and
after pressing the second component onto the assembly the second time, heating the first component and the assembly to a second minimum temperature for a third minimum period of time.

2. The method of claim 1, wherein assembly further includes a second sliding mechanism arranged on the first component, and the method further comprises rotating the second sliding mechanism relative to the first component prior to pressing the second component onto the assembly a second time.

3. The method of claim 1, further comprising, prior to heating the assembly to the first minimum temperature, placing the assembly on a fixture in order to provide support for the assembly during processing.

4. The method of claim 1, further comprising, attaching a thermistor to the first component.

5. The method of claim 4, further comprising, using the thermistor to confirm that the first component has been heated to the first minimum temperature for the first minimum period of time.

6. The method of claim 4, further comprising, using the thermistor to confirm that the first component has been heated to the second minimum temperature for the third minimum period of time.

7. The method of claim 1, further comprising, after pressing the second component onto the assembly the first time and prior to the subjecting allowing the first component to gradually cool to a particular temperature.

8. The method of claim 7, wherein the particular temperature is at or less than 25 C.

9. The method of claim 1, further comprising, after the subjecting, allowing the first component to gradually cool to a particular temperature.

10. The method of claim 9, wherein the particular temperature is at or less than 25 C.

11. The method of claim 1, further comprising, after heating the first component and the assembly to the second minimum temperature for the third minimum period of time, allowing the first component to gradually cool to a particular temperature.

12. The method of claim 11, wherein the particular temperature is at or less than 25 C.

13. The method of claim 1, wherein the first minimum temperature is at least 85 C.

14. The method of claim 13, wherein the first minimum period of time is at least 15 minutes.

15. The method of claim 1, wherein the second minimum temperature is at least 85 C.

16. The method of claim 15, wherein the third minimum period of time is at least 15 minutes.

17. The method of claim 1, wherein the third minimum period of time is at least 15 minutes.

18. The method of claim 1, wherein the rotating includes rotating the sliding mechanism between 90 and 180 degrees relative to the first component.

19. The method of claim 1, wherein the sliding mechanism is a graphite-filled PTFE O-ring.

20. The method of claim 1, wherein the first component, second component, and the first sliding mechanism are components of a preloading mechanism, and the method further comprises, after heating the first component and the assembly to the second minimum temperature for the third minimum period of time, assembling the preloading mechanism.
